(19) United States
(12) Patent Application Publication
(10) Pub. No.: US 2025/0033761 A1
(43) Pub. Date: Jan. 30, 2025

(54) FLIGHT DEVICE

(71) Applicant: Kubota Corporation, Osaka (JP)

(72) Inventors: Mitsuru ISHIKAWA, Ota-shi (JP); Masakazu YAMAZAKI, Ota-shi (JP)

(21) Appl. No.: 18/910,473

(22) Filed: Oct. 9, 2024

Related U.S. Application Data
(63) Continuation of application No. PCT/JP2023/013970, filed on Apr. 4, 2023.

(30) Foreign Application Priority Data
Apr. 12, 2022 (JP) 2022-065773

(51) Int. Cl. B64C 11/48

(52) U.S. Cl. CPC B64C 11/48

(57) ABSTRACT

A flight device in which vibrations and anti-torque generated during flight can be effectively reduced includes a first engine, a second engine, a first transmission shaft rotated by the first engine, a second transmission shaft rotated by the second engine, a first rotor rotated by the first transmission shaft, and a second rotor rotated by the second transmission shaft. The first transmission shaft has a hollow structure, and the second transmission shaft is located inside the first transmission shaft.

### CROSS REFERENCE TO RELATED APPLICATIONS

This application claims the benefit of priority to Japanese Patent Application No. 2022-065773 filed on Apr. 12, 2022 and is a Continuation application of PCT Application No. PCT/JP2023/013970 filed on Apr. 4, 2023. The entire contents of each application are hereby incorporated herein by reference.

### BACKGROUND OF THE INVENTION

### 1. Field of the Invention

The present invention relates to flight devices and specifically relates to flight devices in each of which a rotor is driven by an engine.

### 2. Description of the Related Art

Flight devices capable of unmanned flight in the air have been known. Such a flight device is able to fly in the air using the thrust of a rotor rotating about a vertical axis.

Application fields of such flight devices include the field of transportation, the field of surveying, and the field of photography, for example. In the case of applying the flight devices to such fields, surveying equipment and photography equipment are attached to the flight devices. When the flight devices are applied to such fields, the flight devices can fly in areas that human cannot access and perform transportation, photographing, and surveying of such areas. Inventions relating to such flight devices are described in Japanese Unexamined Patent Application Publication No. 2012-51545 and Japanese Unexamined Patent Application Publication No. 2014-240242, for example.

In a typical flight device, the rotor rotates using electric power supplied from a storage battery mounted on the flight device. However, energy supply by the electric power of the storage battery may not always be sufficient. In order to implement a continuous flight over a long period of time, flight devices equipped with engines also have emerged. In such a flight device, a generator is rotated using driving force of the engine, and the rotor is rotationally driven using electric power generated by the generator. In flight devices having such a configuration, the engine and the generator are connected in series on a path of energy supplied from the power source to the rotor. Such a flight device is therefore called a series-type drone. Use of such flight devices enables photography and surveying of wide areas. A flight device equipped with an engine is described in Japanese Unexamined Patent Application Publication No. 2011-251678, for example. Furthermore, parallel-type hybrid drones are also gradually emerging, in which the main rotor is mechanically rotated using the driving force of the engine and a sub-rotor is rotated using a motor.

### SUMMARY OF THE INVENTION

However, the conventional flight devices described above still have a room for improvement in the driving system mechanism.

Specifically, many drones, as existing flight devices, include plural motors or engines, and because of remaining vibrations or anti-torque due to engines, it is difficult to accurately control the position and orientation of drones in the air. Furthermore, remaining vibrations or anti-torque due to generators also cause a similar problem.

To solve these problems, a gear box or the like may be provided in the drive transmission system. However, such a configuration will increase the complexity of the overall structure of the drone and increase its weight, thus reducing the continuous flight time of the drone.

The counter-torque generated by rotors can be cancelled out by using coaxial rotors. However, in such cases, the aforementioned problems will become more obvious.

Example embodiments of the present invention provide flight devices in each of which vibrations and anti-torque generated during flight are effectively reduced.

A flight device according to an example embodiment of the present invention includes an engine, a transmission shaft, and a rotor, wherein the engine includes a first engine and a second engine, the transmission shaft includes a first transmission shaft rotated by the first engine and a second transmission shaft rotated by the second engine and an upper end connected to the rotor, the rotor includes a first rotor rotated by the first transmission shaft and a second rotor rotated by the second transmission shaft, the first transmission shaft has a hollow structure, the second transmission shaft is inside the first transmission shaft, the first engine includes a first piston, a first crankshaft, and a first connecting rod rotatably connecting the first piston and the first crankshaft, the second engine includes a second piston, a second crankshaft, and a second connecting rod rotatably connecting the second piston and the second crankshaft, the first transmission shaft and the first crankshaft are drivingly connected with a first drive transmission interposed therebetween, the second transmission shaft and the second crankshaft are drivingly connected with a second drive transmission interposed therebetween, and as seen from above, the first engine and the second engine face each other with the first transmission shaft and the second transmission shaft interposed therebetween.

In a flight device according to an example embodiment of the present invention, the engine further includes a third engine and a fourth engine, the first rotor is rotated by the first engine and the third engine, and the second rotor is rotated by the second engine and the fourth engine.

In a flight device according to an example embodiment of the present invention, the first crankshaft and the second crankshaft rotate in opposite directions.

A flight device according to an example embodiment of the present invention further includes a first generator driven by the first engine and a second generator driven by the second engine.

A flight device according to an example embodiment of the present invention further includes a sub-rotor rotationally driven by a motor.

In a flight device according to an example embodiment of the present invention, the engine includes a counter-rotation mechanism to cause the first crankshaft and the second crankshaft to rotate in opposite directions.

A flight device according to an example embodiment of the present invention includes an engine, a transmission shaft, and a rotor, in which the engine includes a first engine and a second engine, the transmission shaft includes a first transmission shaft rotated by the first engine and a second transmission shaft rotated by the second engine, the rotor includes a first rotor rotated by the first transmission shaft and a second rotor rotated by the second transmission shaft, the first transmission shaft has a hollow structure, and the second transmission shaft is inside the first transmission shaft. The engine includes the first engine and the second engine so that vibrations and torque generated by the engines cancel each other out. This reduces vibrations and the like generated by the engine during flight, thus stabilizing the position and orientation during flight.

Still furthermore, in a flight device according to an example embodiment of the present invention, the engine further includes a third engine and a fourth engine, the first rotor is rotated by the first engine and the third engine, and the second rotor is rotated by the second engine and the fourth engine. According to this example embodiment, use of the third engine and the fourth engine as a power source in addition to the first engine and the second engine improve the output of the rotor.

Still furthermore, in a flight device according to an example embodiment of the present invention, the first crankshaft and the second crankshaft rotate in opposite directions. Thus, the rotation direction of the first crankshaft is opposite to that of the second crankshaft, so that the moments generated by rotation of the rotor cancel each other out. This can further improve the stability during flight.

Still furthermore, a flight device according to an example embodiment of the present invention further includes a first generator driven by the first engine and a second generator driven by the second engine. Driving the first generator and the second generator can produce electric energy necessary for flight.

Still furthermore, a flight device according to an example embodiment of the present invention further includes a sub-rotor rotationally driven by a motor. It is therefore possible to more effectively control the position and orientation during flight due to the sub-rotor.

In a flight device according to an example embodiment of the present invention, the engine includes a counter-rotation mechanism to cause the first crankshaft and the second crankshaft to rotate in opposite directions. It is therefore possible to more effectively cancel out moments generated by rotation of the rotors and further improve the stability during flight.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a plan view of a flight device according to an example embodiment of the present invention.

FIG. 2 is a cross-sectional view of a flight device according to an example embodiment of the present invention.

FIG. 3 is a block diagram illustrating a connection configuration of a flight device according to an example embodiment of the present invention.

FIG. 4 is a cross-sectional view of a portion of a flight device according to another example embodiment of the present invention.

FIG. 5 is a side view of a flight device according to still another example embodiment of the present invention.

### DETAILED DESCRIPTION OF THE EXAMPLE EMBODIMENTS

Hereinafter, configurations of flight devices according to example embodiments will be described with reference to the drawings. In the following description, portions having the same configurations are denoted by the same reference numerals, and the description thereof will not be repeated. The following description will use up, down, front, back, right, and left directions, but these directions are for convenience of explanation. A flight device 10 is also called a drone and specifically also called a parallel-type hybrid drone. The parallel-type hybrid drone is a drone including a rotor mechanically driven by an engine and a rotor driven by a motor.

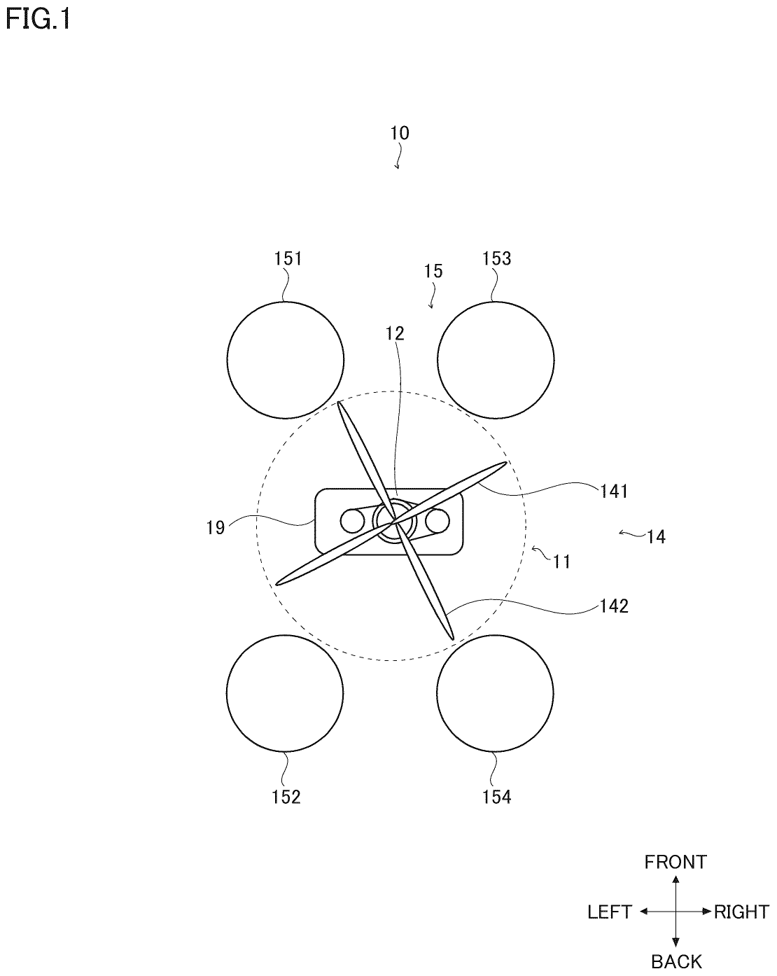

FIG. 1 is a plan view of the flight device 10 as seen from above.

The flight device 10 mainly includes an engine 11, a transmission shaft 12, and rotors 14. The flight device 10 is a parallel-type hybrid drone including two driving systems in parallel, an electric driving system and a mechanical driving system. The electric driving system rotates motors 21 and sub-rotors 15, which will be described later. The mechanical driving system rotates the rotors 14, which will be described later.

The airframe 19 is a body supporting the structural elements or components of the flight device 10 and is made of synthetic resin, metal, or a composite material thereof.

The rotors 14 rotate to generate driving force necessary for the airframe 19 to float. The rotors 14 include a first rotor 141 and a second rotor 142. The first rotor 141 and the second rotor 142 define a contra-rotating propeller. The first rotor 141 and the second rotor 142 rotate in opposite directions at the same rotational speed. For example, in top view, the first rotor 141 rotates counterclockwise while the second rotor 142 rotates clockwise. The rotors 14 are main rotors mechanically rotated by driving force of the engine 11.

The flight device 10 includes the sub-rotors 15. The sub-rotors 15 include sub-rotors 151 to 154. The sub-rotors 15 rotate to control the position and orientation of the flight device 10 during flight.

The sub-rotor 151 is positioned at the front left of the airframe 19 and is rotated by a motor 211, which will be described later. The sub-rotor 152 is positioned at the back left of the airframe 19 and is rotated by a motor 212, which will be described later. The sub-rotor 153 is positioned at the front right of the airframe 19 and is rotated by a motor 213, which will be described later. The sub-rotor 154 is positioned at the back right of the airframe 19 and is rotated by a motor 214, which will be described later.

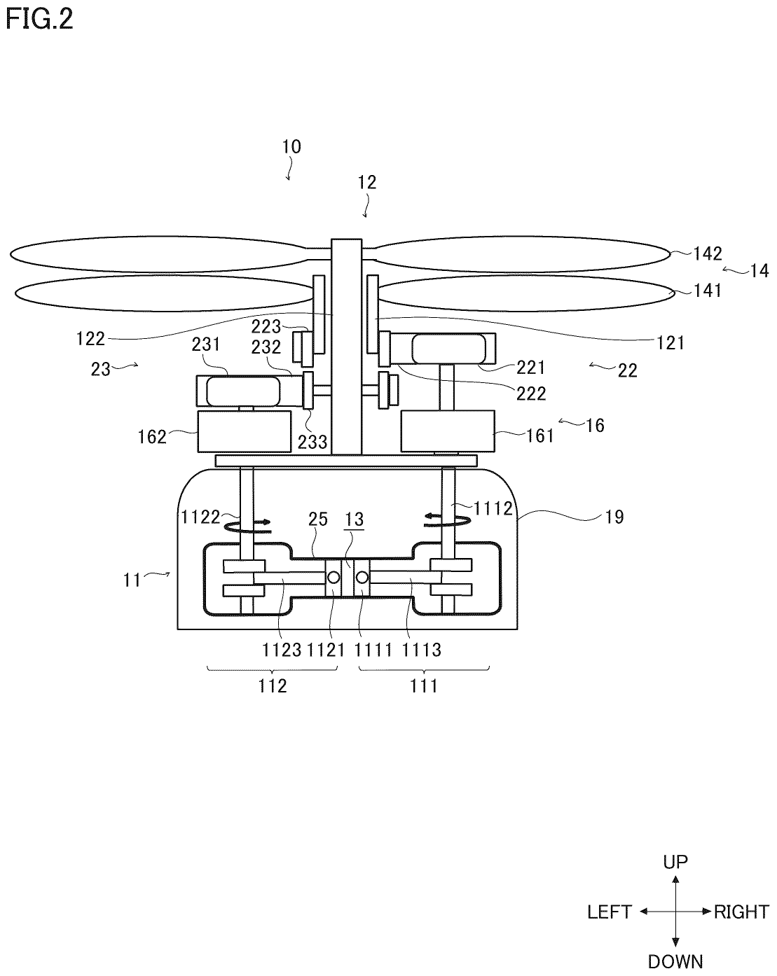

FIG. 2 is a cross-sectional view of the flight device 10.

In the flight device 10, the engine 11 is accommodated within the airframe 19, and the rotors 14 are provided above the airframe 19.

The engine 11 includes a first engine 111 and a second engine 112.

The first engine 111 includes a first piston 1111, a first crankshaft 1112, and a first connecting rod 1113, which rotatably connects the first piston 1111 and the first crankshaft 1112. The first crankshaft 1112 of the first engine 111 protrudes upward from the upper surface of the airframe 19.

The second engine 112 includes a second piston 1121, a second crankshaft 1122, and a second connecting rod 1123, which rotatably connects the second piston 1121 and the second crankshaft 1122. The second crankshaft 1122 of the second engine 112 protrudes upward from the upper surface of the airframe 19.

The first piston 1111 of the first engine 111 and the second piston 1121 of the second engine 41 share a combustion chamber 13. In other words, the first piston 1111 and the second piston 1121 reciprocate within a single continuous cylinder 25. By the first piston 1111 and the second piston 1121 simultaneously making stroke toward the center, it is possible to achieve a high expansion ratio of gas mixture in the combustion chamber 13 while reducing the stroke amount.

The engine 11 includes a volume space (not illustrated herein) communicating with the combustion chamber 13. A spark plug is provided in the volume space. In the combustion chamber 13, an intake port and an exhaust port, which are not illustrated herein, are provided. An air-mixture containing fuel, such as gasoline, is introduced into the combustion chamber 13 through the intake port, and exhaust gas after combustion is discharged from the combustion chamber 13 to the outside through the exhaust port.

The engine 11 configured as described above operates as follows. First, in an intake stroke, the first piston 1111 and the second piston 1121 move outward from the center within the cylinder 25 to introduce air mixture, as a mixture of air and fuel, into the cylinder 25. Next, in a compression stroke, the first piston 1111 and the second piston 1121 are forced toward the center due to inertia of the first and second crankshafts 1112 and 1122 that are rotating, and the air mixture is compressed within the cylinder 25. Then, in a combustion stroke, the not-illustrated spark plug ignites in the combustion chamber 13, and the air mixture burns within the cylinder 25. The first piston 1111 and the second piston 1121 are forced to the respective outer ends, which are bottom dead centers. Then, in an exhaust stroke, the first piston 1111 and the second piston 1121 are forced inward due to inertia of the first and second crankshafts 1112 and 1122 that are rotating. The gas remaining within the cylinder 25 after combustion is discharged to the outside.

In the engine 11, the two first and second pistons 1111 and 1121, which reciprocate within the single cylinder 25, can share strokes. Compared to typical gasoline engines, therefore, the compression ratio of gas mixture can be increased. Since the first piston 1111 and the second piston 1121 face each other within the cylinder 25, the engine 11 does not need a cylinder head that is necessary for general engines. The engine 11 therefore has a simple structure and light weight. The structural elements or components included in the engine 11, that is, the first and second pistons 1111 and 1121, the first and second crankshafts 1112 and 1122, or the like are symmetrically positioned opposite to each other and operate in a synchronized manner. Vibrations generated from the structural elements or components of the engine 11 are canceled by each other, so that vibrations generated by the entire engine 11 and transmitted to the outside can be reduced or prevented. The torque and the moments generated by rotation of the structural elements or components of the engine 11 are canceled almost completely.

By mounting the engine 11 on the flight device 10, the flight device 10 can be reduced in size, weight, vibrations, and reduction of counter-torque. Due to the reduction in vibrations in particular, it is possible to prevent delicate equipment, such as arithmetic control devices and GPS sensors, etc., from being adversely affected by orientation control or motor output control. Furthermore, it is possible to prevent parcels being transported by the flight device 10 from being damaged by vibrations.

The engine 11 is provided with a counter-rotation synchronization mechanism not illustrated herein. The counter-rotation synchronization mechanism causes the first crankshaft 1112 and the second crankshaft 1122 to rotate in opposite directions. Furthermore, the counter-rotation synchronization mechanism synchronizes reciprocating motions of the first piston 1111 and the second piston 1121. In the engine 11, therefore, the first crankshaft 1112 and the second crankshaft 1122 rotate in opposite directions in principle. The structural elements or components drivingly connected to the first crankshaft 1112 and the structural elements or components drivingly connected to the second crankshaft 1122 therefore rotate in opposite directions without a special reversing mechanism. The first rotor 141 and the second rotor 142, which are illustrated in FIG. 2, therefore rotate in opposite directions at the same rotational speed without any special reversing mechanism. The other structural elements or components rotationally driven by the first crankshaft 1112 and the second crankshaft 1122 rotate in opposite directions at the same rotational speed without any special reversing mechanism.

The first generator 161 is arranged above the airframe 19 and is rotationally driven by the first crankshaft 1112. Specifically, the first generator 161 includes a not-illustrated rotor, and this rotor is connected to the first crankshaft 1112 so as not to rotate relative to the first crankshaft 1112. With this configuration, the rotor incorporated in the first generator 161 rotates together with the first crankshaft 1112 to implement power generation of the first power generator 161, thus generating electric energy.

The second generator 162 preferably has the same configuration as the first generator 161, for example. Specifically, the second generator 162 is arranged above the airframe 19 and is rotationally driven by the second crankshaft 1122. The second generator 162 includes a not-illustrated rotor, and this rotor is connected to the second crankshaft 1122 so as not to rotate relative to the second crankshaft 1122. With this configuration, the rotor incorporated in the second generator 162 rotates together with the second crankshaft 1122 to implement power generation of the second power generator 162, thus generating electric energy.

The transmission shaft 12 is a substantially shaft-shaped body that is rotated by the driving force generated by the engine 11 to rotate the aforementioned rotors 14. The transmission shaft 12 includes a first transmission shaft 121, which is rotated by the first engine 111, and a second transmission shaft 122, which is rotated by the second engine 112. The transmission shaft 12 includes mechanisms mechanically and coaxially rotated in opposite directions as described later.

The upper end of the first transmission shaft 121 is connected to the first rotor 141, and the first rotor 141 is rotated as a result. The first transmission shaft 121 is provided so as to rotate relative to the upper surface of the airframe 19. A lower end portion of the first transmission shaft 121 is drivingly connected to the first crankshaft 1112 with a first drive transmission 22 (described later) interposed therebetween. That is, the rotational driving force generated by the first engine 111 is transmitted through the first crankshaft 1112 and the first drive transmission 22 to the first transmission shaft 121.

The upper end of the second transmission shaft 122 is connected to the second rotor 142, and the second rotor 142 is rotated as a result. The second rotor 142 is provided so as to rotate relative to the upper surface of the airframe 19. A lower end portion of the second transmission shaft 122 is drivingly connected to the second crankshaft 1122 with a second drive transmission 23 (described later) interposed therebetween. That is, the rotational driving force generated by the second engine 112 is transmitted through the second crankshaft 1122 and the second drive transmission 23 to the second transmission shaft 122.

The first transmission shaft 121 has a hollow structure, and the second transmission shaft 122 is located inside the first transmission shaft 121. Specifically, a cylindrical or substantially cylindrical space is defined inside the first transmission shaft 121, and the second transmission shaft 122 penetrates or occupies at least a portion of the space. The upper end of the second transmission shaft 122 is positioned above the upper end of the first transmission shaft 121. Furthermore, the lower end of the second transmission shaft 122 is positioned below the lower end of the first transmission shaft 121. That is, the first transmission shaft 121 and the second transmission shaft 122 define a coaxial contra-rotating structure.

The first drive transmission 22 transmits the rotational driving force of the first crankshaft 1112 to the first transmission shaft 121. Specifically, the first drive transmission 22 includes a first engine-side pulley 221, a first belt 222, and a first transmission shaft-side pulley 223. The first engine-side pulley 221 is connected to the upper end of the first crankshaft 1112 so as not to rotate relative to the first crankshaft 1112. The first transmission shaft-side pulley 223 is connected to the lower end of the first transmission shaft 121 so as not to rotate relative to the first transmission shaft 121. The first belt 222 is laid over the first engine-side pulley 221 and the first transmission shaft-side pulley 223. With this configuration, during flight of the flight device 10, the first crankshaft 1112 and the first engine-side pulley 221 are rotated due to operation of the first engine 111. Furthermore, the rotational driving force of the first engine-side pulley 221 is transmitted to the first transmission shaft-side pulley 223 through the first belt 222. The first transmission shaft 121 and the first rotor 141 rotate as a result.

The second drive transmission 23 preferably has the same configuration as the first drive transmission 22. That is, the second drive transmission 23 transmits the rotational driving force of the second crankshaft 1122 to the second transmission shaft 122. Specifically, the second drive transmission 23 includes a second engine-side pulley 231, a second belt 232, and a second transmission shaft-side pulley 233. The second engine-side pulley 231 is connected to the upper end of the second crankshaft 1122 so as not to rotate relative to the second crankshaft 1122. The second transmission shaft-side pulley 233 is connected to middle portion of the second transmission shaft 122 so as not to rotate relative to the second transmission shaft 122. The second belt 232 is laid over the second engine-side pulley 231 and the second transmission shaft-side pulley 233. With this configuration, during flight of the flight device 10, the second crankshaft 1122 and the second engine-side pulley 231 are rotated due to operation of the second engine 112. Furthermore, the rotational driving force of the second engine-side pulley 231 is transmitted to the second transmission shaft-side pulley 233 through the second belt 232. The second transmission shaft 122 and the second rotor 142 rotate as a result.

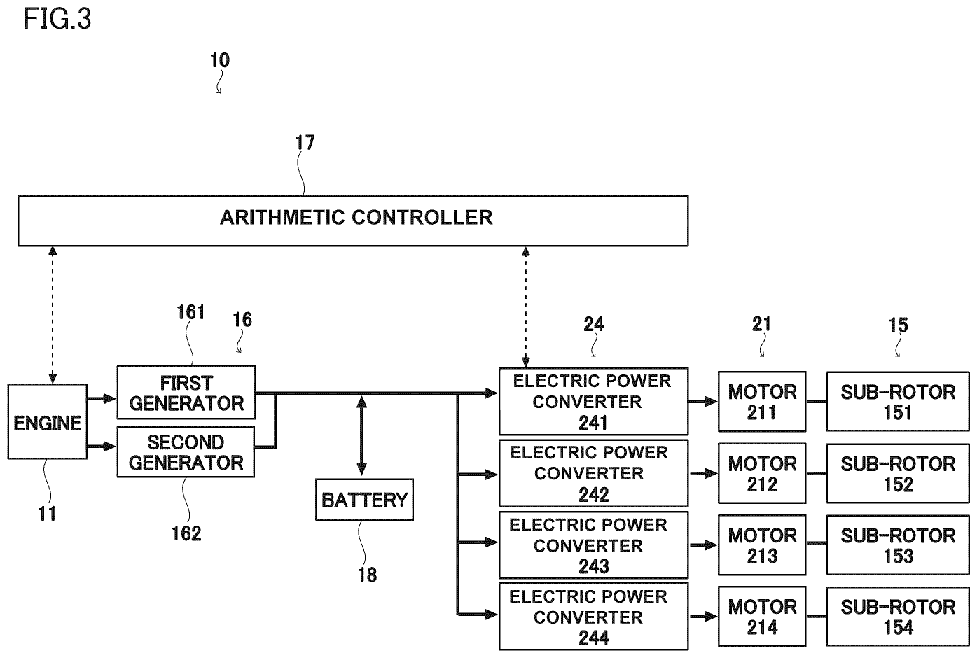

FIG. 3 is a block diagram illustrating the connection configuration of the flight device 10.

The flight device 10 mainly includes the arithmetic controller 17, the engine 11, generators 16, a battery 18, electric power converters 24, the motors 21, and the sub-rotors 15.

The arithmetic controller 17 may include a CPU, a ROM, a RAM, and the like. The arithmetic controller 17 is configured or programmed to control the behavior of each element or component of the flight device 10 based on inputs from various sensors and a controller not illustrated herein. The arithmetic controller 17 is configured or programmed to define or function as a flight controller to control the rotational speed of the rotors 14 and sub-rotors 15 based on inputs from various sensors.

The engine 11 operates based on input signals from the arithmetic controller 17 and generates kinetic energy necessary for the flight device 10 to fly.

The generators 16 are configured or programmed to generate electric power by using a portion of the driving force of the engine 11 and include first and second generators 161 and 162. The first generator 161 is driven by the first engine 111 of the engine 11, which will be described above. The second generator 162 is driven by the second engine 112 of the engine 11.

The battery 18 is interposed between the generators 16 and the electric power converters 24. The battery 18 is charged by the generators 16. The electric power discharged from the battery 18 is supplied to the electric power converters 24, which will be described later.

The electric power converters 24 are provided to correspond to the respective sub-rotors 15. Each electric power converter 24 may include a converter and an inverter to first convert alternating-current power supplied from the second generator 162 into direct-current power and then convert the direct-current power into alternating-current power with a predetermined frequency. Each electric power converter 24 also may include an inverter to convert direct-current power supplied from the battery 18 into alternating-current power with a predetermined frequency. Specifically, the electric power converters 24 include electric power converters 241, 242, 243, and 244.

The motors 21 are provided to correspond to the respective sub-rotors 15. The motors 21 include motors 211, 212, 213, and 214. The motors 211, 212, 213, and 214 rotate at a predetermined speed using electric power supplied from the electric power converters 241 to 244, respectively.

The sub-rotors 15 include the sub-rotors 151 to 154 as described above. The sub-rotors 151 to 154 are rotated by the motors 211 to 214, respectively.

The flight status of the flight device 10 will be briefly described. The flight device 10 is operated in a landing state, a takeoff state, a hovering state, an ascending-descending state, a horizontal movement state, and an emergency flight state.

In the landing state, the flight device 10 is in contact with the ground. In this state, the engine 11 is not running, and the rotors 14 do not rotate.

In the takeoff state, the flight device 10 is rising away from the contact surface mainly due to the thrust generated by rotation of the rotors 14.

In the hovering state, based on an instruction from the arithmetic controller 17, the rotors 14 are rotated by driving force generated by the engine 11 to keep the flight device 10 floating at a predetermined position in the air. In this process, the sub-rotors 15 are rotating based on an instruction from the arithmetic controller 17. The arithmetic controller 17 controls the electric power converters 24 to set the rotational speeds of the motors 21 and sub-rotors 15 to predetermined values so that the flight device 10 can maintain its predetermined altitude and orientation.

In the ascending-descending state, the rotational speed of the engine 11 is controlled to raise or lower the flight device 10. In this process as well, the arithmetic controller 17 controls the electric power converters 24 to set the rotational speeds of the motors 21 and sub-rotors 15 to predetermined values so that the flight device 10 can maintain its predetermined altitude and orientation.

In the horizontal movement state, the arithmetic controller 17 controls the electric power converters 24 to control the rotational speeds of the motors 21 and sub-rotors 15 so that the flight device 10 be tilted. In this process as well, the arithmetic controller 17 controls the running state of the engine 11 to rotate the rotors 14 at a predetermined speed.

In the emergency flight state, the arithmetic controller 17 forces the flight device 10 that is flying to land.

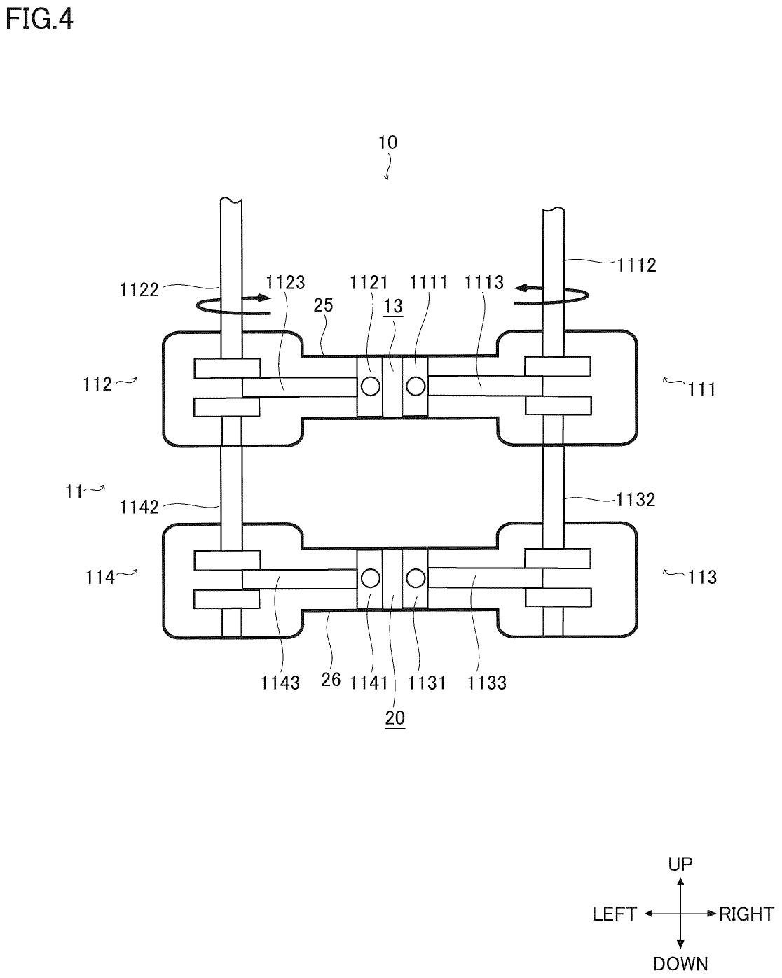

FIG. 4 is a cross-sectional view of a portion of the engine 11 of the flight device 10 according to another example embodiment. The engine 11 illustrated in FIG. 4 includes a third engine 113 and a fourth engine 114, in addition to the first engine 111 and the second engine 112. That is, the engine 11 includes four engines. The above-described first rotor 141 is rotated by the first engine 111 and the third engine 113, and the above-described second rotor 142 is rotated by the second engine 112 and the fourth engine 114. The flight device 10 illustrated in FIG. 4 is the same as that illustrated in FIG. 1 except for the configuration of the engine 11.

The third engine 113 and the fourth engine 114 face each other along the right-left direction.

The third engine 113 includes a third piston 1131, a third crankshaft 1132, and a third connecting rod 1133, which rotatably connects the third piston 1131 and the third crankshaft 1132. The third crankshaft 1132 of the third engine 113 continues to the first crankshaft 1112 of the first engine 111 in an integrated manner.

The fourth engine 114 includes a fourth piston 1141, a fourth crankshaft 1142, and a fourth connecting rod 1143, which rotatably connects the fourth piston 1141 and the fourth crankshaft 1142. The fourth crankshaft 1142 of the fourth engine 114 continues to the second crankshaft 1122 of the second engine 112 in an integrated manner.

The third piston 1131 and the fourth piston 1141 reciprocate within a cylinder 26. The third piston 1131 and the fourth piston 1141 share a combustion chamber 20. With this configuration, in the same manner as described above, it is possible to substantially completely remove the counter torque generated by the third engine 113 and the fourth engine 114 running. Furthermore, the third engine 113 performs the intake, compression, combustion, and exhaust strokes in synchronization with the first engine 111. The fourth engine 114 performs the intake, compression, combustion, and exhaust strokes in synchronization with the second engine 112.

In the flight device 10 illustrated in FIG. 4, the third engine 113 and the fourth engine 114 are used as a power source in addition to the first engine 111 and the second engine 112, thus increasing the output of the rotors 14.

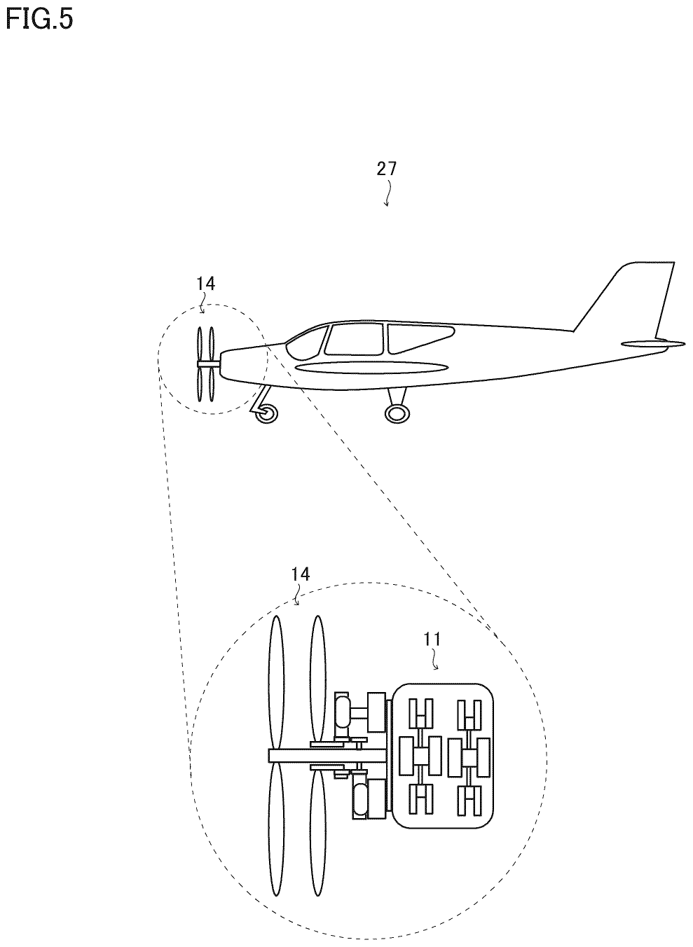

FIG. 5 is a side view of a flight device 27 according to still another example embodiment.

The flight device 27 is a fixed-wing propeller aircraft having wings fixed to the fuselage. The flight device 27 includes the rotors 14 at the tip of the airframe. The rotors 14 are rotationally driven by the engine 11 arranged at the front end of the airframe. The configuration of the structural elements or components that drive the engine 11 and the rotors 14 are the same as that of the flight device 10 described above.

Providing the engine 11 for the flight device 27 reduces vibrations and torque generated by the engine 11 running, thus improving the stable flight and comfortability of the flight device 27.

Hereinabove, some of the example embodiments of the present invention have been described. However, the present invention is not limited to the aforementioned example embodiments and can be changed without departing from the spirit of the present invention. Furthermore, various features, characteristics, elements, components, functions, etc., of the above-described example embodiments can be combined.

In the example illustrated with reference to FIG. 2, the first drive transmission 22 and the second drive transmission 23 include the belts but can have different drive transmission mechanisms. For example, the first drive transmission 22 and the second drive transmission 23 can include a gear train or the like.

With reference to FIG. 2, the flight device 10 is a parallel-type hybrid drone but may be an engine-type drone that only includes the rotors 14 but not the sub-rotors 15. In this case, the orientation control of the flight device 10 during flight can be implemented by pitch control of the rotors 14.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A flight device comprising:
an engine;
a transmission shaft; and
a rotor; wherein
the engine includes a first engine and a second engine;
the transmission shaft includes a first transmission shaft rotated by the first engine and a second transmission shaft rotated by the second engine and an upper end connected to the rotor;
the rotor includes a first rotor rotated by the first transmission shaft and a second rotor rotated by the second transmission shaft;
the first transmission shaft has a hollow structure,
the second transmission shaft is inside the first transmission shaft;
the first engine includes a first piston, a first crankshaft, and a first connecting rod rotatably connecting the first piston and the first crankshaft;
the second engine includes a second piston, a second crankshaft, and a second connecting rod rotatably connecting the second piston and the second crankshaft;
the first transmission shaft and the first crankshaft are drivingly connected with a first drive transmission interposed therebetween;
the second transmission shaft and the second crankshaft are drivingly connected with a second drive transmission interposed therebetween; and
as seen from above, the first engine and the second engine face each other with the first transmission shaft and the second transmission shaft interposed therebetween.

2. The flight device according to claim 1, wherein
the engine further includes a third engine and a fourth engine;
the first rotor is rotated by the first engine and the third engine; and
the second rotor is rotated by the second engine and the fourth engine.

3. The flight device according to claim 1, wherein the first crankshaft and the second crankshaft rotate in opposite directions.

4. The flight device according to claim 1, further comprising a first generator driven by the first engine and a second generator driven by the second engine.

5. The flight device according to claim 1, further comprising a sub-rotor that is rotationally driven by a motor.

6. The flight device according to claim 1, wherein
the engine includes a counter-rotation mechanism to cause the first crankshaft and the second crankshaft to rotate in opposite directions.
